(19) United States
(12) Patent Application Publication
(10) Pub. No.: US 2003/0226615 A1
(43) Pub. Date: Dec. 11, 2003

(54) Liquid dispensing system and method including same

(76) Inventor: Todd Renell Allen, Langhorne, PA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/165,997

(22) Filed: Jun. 10, 2002

(51) Int. Cl. B65B 31/00; B67C 3/00

(52) U.S. Cl. 141/6

(57) ABSTRACT

The present invention is directed to liquid dispensing systems and methods for filling containers with liquid products. Each of the disclosed systems and methods includes a pump that employs an engineered bellows for design stability and for highly accurate and repeatable liquid dosing.

### FIELD OF THE INVENTION

The present invention is directed to liquid dispensing apparatuses, systems and methods for filling containers with liquid products.

### BACKGROUND OF THE INVENTION

Product filling operations generally comprise one or more pumps. The pumps and the remaining wetted components must be disassembled and cleaned between product batches. This results in a loss of manufacturing opportunity (machine downtime), as well as the generation of a chemical waste stream containing cleaning and sanitization materials.

Many industrial pump manufacturers have attempted to make the wetted surfaces of their pumps easier to clean through non-fouling surfaces, such as, for example, highly polished surfaces, or through designs incorporating disposable replacement parts. Equipment manufacturers have also attempted to make pumps easier to remove from service and to disassemble. Unfortunately, the improvements often come with a compromise in accuracy and repeatability.

Thus, there is still a need for a dispensing system employing inexpensive wetted components that can either be cleaned or disposed, and that provide repeatable and accurate dosing for a range of product lines.

### SUMMARY OF THE INVENTION

The present invention is directed to methods for filling a plurality of containers with a liquid product. In accordance with one of the preferred embodiments provided by the present invention, there has now been provided a method for filling a plurality of containers with a liquid product using a pump. The pump includes a bellows including a plurality of corrugations, an inlet conduit in fluid communication with a cavity defined by the bellows, an outlet conduit in fluid communication with the cavity, and a controlled linear actuator for compressing the bellows. The method is capable of filling containers having a volume of at least about 50 ml with a single compression cycle of the bellows.

The present invention is also directed to liquid dispensing systems for filling containers with liquid products. In accordance with one of the preferred embodiments of the present invention, there has now been provided a liquid dispensing system having a pump. The pump includes a bellows, inlet and outlet conduits that are in fluid communication with a cavity defined by the bellows, and a controlled linear actuator for compressing the bellows. The bellows includes a plurality of corrugations and a single cycle displacement volume of at least about 50 ml. The corrugations include substantially rigid sidewalls such that ballooning of the sidewalls is prevented at an internal pressure of about 4 bar.

In accordance with another of the preferred embodiments of the present invention, there has now been provided a liquid dispensing system including a wetted components assembly and an actuator. The wetted components assembly includes a bellows, an inlet conduit, and an outlet conduit. The bellows includes a closed end and an opposing end having a single opening formed therein, a plurality of corrugations, a cavity defined by the bellows, and a single cycle displacement volume of at least about 50 ml. The inlet and outlet conduits are in fluid communication with the single opening such that fluid can be drawn into and displaced out of the bellows as the bellows expands and contracts, respectively. Each of the inlet and outlet conduits comprises a one-way valve. The actuator compresses the bellows through force applied to the bellows exterior.

In accordance with another of the preferred embodiments of the present invention, there has now been provided a liquid dispensing system for filling containers with a liquid product, the system including a wetted components assembly, a support member, a quick-release coupling for securing the wetted components assembly to the support member, and a controlled linear actuator. The wetted components assembly includes a bellows, an inlet conduit for communicating a liquid product from a product source to a cavity defined by the bellows, and an outlet conduit for communicating the liquid product from the cavity to a product container.

These and various other features of novelty are pointed out with particularity in the claims annexed hereto and forming a part hereof. However, for a better understanding of aspects of the invention, reference should be made to the drawings which form a further part hereof, and to the accompanying descriptive matter, in which there is illustrated preferred embodiments.

### BRIEF DESCRIPTION OF THE DRAWINGS

The present invention is believed to be best understood through the following detailed description of the preferred embodiments and the accompanying drawings wherein like reference numerals indicate like features, and wherein:

FIG. 1 is a perspective view of an exemplary bellows embodiment provided by the present invention;

FIG. 2 is a cross-section of the bellows shown in FIG. 1;

FIG. 3 is a simulation of bellow sidewall ballooning;

FIG. 4 is a perspective view of an end cap for covering an open end of a bellows such as that shown in FIG. 1;

FIG. 5 is a side view of an alternative bellows embodiment provided by the present invention;

FIG. 6 is a side view of an exemplary wetted assembly according to the present invention, the assembly comprising a bellows, a fitting, an inlet conduit including a one-way valve and an outlet conduit including a one-way valve; and

FIG. 7 is a side view of a wetted assembly provided by the present invention, similar to that shown in FIG. 6, being attached to a support member with a quick-release coupling, and an actuator for compressing the bellows included in the wetted assembly.

### DETAILED DESCRIPTION OF THE PREFERRED EMBODIMENTS

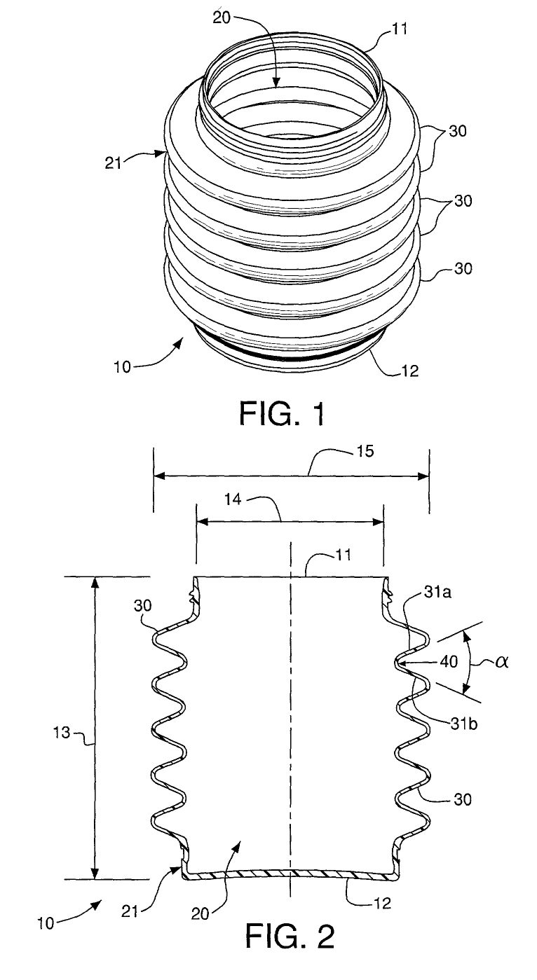

Dispensing systems and methods of the present invention include a pump for displacing target volumes of a liquid product by drawing liquid into a bellows interior during bellows expansion and then discharging the liquid during bellows compression. Referring now to the drawings, wherein like reference numerals designate corresponding structure throughout the views, and referring in particular to FIGS. 1 and 2, a bellows 10 is provided including ends 11 and 12, a height 13, an inner diameter 14, an outer diameter 15, a cavity 20 (defined by walls of the bellows), an exterior 21, and a plurality of corrugations 30 in the bellows walls. Bellows 10 is shown as having a circular cross-sectional shape throughout the figures. Other shapes and geometries may equally be employed, including, but not limited to, elliptical, square, rectangular, and triangular.

The bellows dimensions may vary depending on the application. As set forth in FIG. 1, the bellows height 13 is preferably from about 5 cm to about 60 cm, and more preferably from about 15 cm to about 30 cm. In preferred embodiments outer diameter 15 ranges from about 2 cm to about 30 cm, while inner diameter 14 ranges from about 1 cm to about 29 cm.

The size of bellows 10 is generally specified by the desired or target volume of product to be dosed by the dispensing system of the present invention, and therefore, various combinations of height, inner diameter and outer diameter are possible, including individual dimensions that are outside of the ranges described above. By way of example, the dispensing system may be used for filling containers with consumer products, such as skin and hair care products. Typical target volumes for these types of products are from about 50 ml to about 1000 ml (although target volumes could be less than 50 ml). Those of ordinary skill in the art would readily appreciate that target volumes will vary according to product type, and storage, shipment and use requirements.

In one embodiment, the bellows provided by the present invention are designed to displace the target volumes with a single compression cycle (that is, one cycle comprises drawing liquid into the bellows cavity during bellows expansion and then discharging the liquid from the cavity during bellows compression). The capability of displacing a target volume in a single cycle will increase the dosing accuracy by limiting any deviation source to a single application for a given volume.

Bellows 10 are capable of expanding and contracting through employment of corrugations 30 in the walls of bellows 10. As used herein, “corrugation” means a structure having alternating ridges and grooves. This includes structures comprising ripples, hinges or living hinges, folds, wrinkles, or the like. Preferably, bellows 10 includes 2 to 20 corrugations, and more preferably 3 to 13 corrugations, as shown in FIG. 2. Each corrugation comprises sidewalls 31a and 31b that are tapered to define an included angle α and a fillet radius 40. Included angle α preferably ranges from about 5 to about 60 degrees. Fillet radius 40 is preferably from about 2 mm to about 10 mm. In one preferred corrugation embodiment the included angle α is about 50 degrees and the fillet radius 40 is about 5 mm.

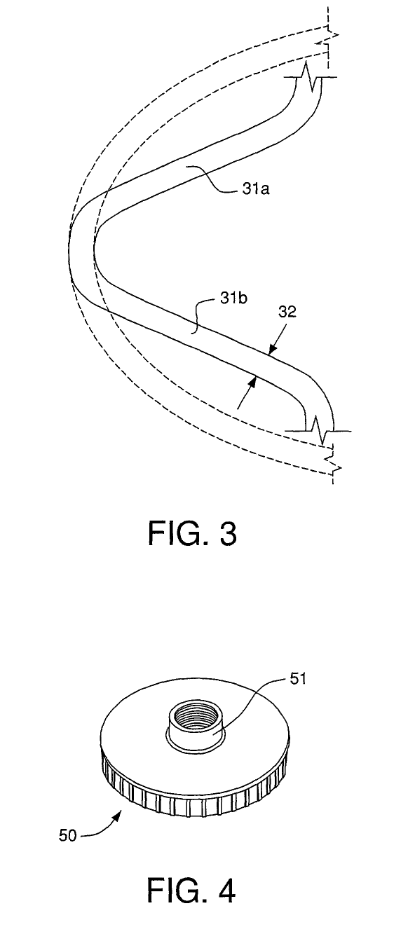

Corrugation sidewalls 31a and 31b are designed preferably to be substantially rigid such that “ballooning” or “bowing” is prevented when pressure inside the bellows cavity 20 is about 4 bar. A simulated ballooning of corrugation sidewalls is shown with a broken line in FIG. 3. This effect is undesirable because it will vary according to changing pressures and the number of compression cycles the bellows undergo (as well as other dynamic pumping conditions), resulting in a volumetric displacement that is neither accurate nor repeatable.

Bellow wall thickness and material choice are two variables (among other process and product variables) that can affect the rigidity of corrugation sidewalls 31a and 31b. Preferably, the wall thickness 32 is from about 10 mm to about 70 mm, and more preferably from about 15 to about 25 mm. It is important to note that certain chosen manufacturing processes for making the bellows, such as, for example, blow molding, may render a non-uniform wall thickness (which is not preferred).

The bellows may be made from numerous different materials, including but not limited to, plastics, metals, and composites thereof. In one preferred embodiment, bellows 10 is made from plastic. A representative, non-limiting, list of plastics includes thermoplastic elastomers, such as, for example, natural rubber, synthetic rubbers such as styrene butadiene rubber, polybutylene, ethylene propylene diene monomer, polyvinyl chloride elastomers, and the like; polyolefins, such as, for example, polyethylene (low density, high density, and combinations thereof) and polypropylene; polyester alloys; polyesters, such as, for example, polyester terephthalate; and polyurethanes. Polyethylene, polypropylene, and blends of the two polyolefins are the preferred materials for manufacture. Suitable metals include, but are not limited to, aluminum; stainless steel including 300 and 400 series; ferrous metals; and coated metals, such as, for example, tool steel coated with a plastic material, TEFLON, aluminum, or gas plasma nitrile.

The bellows may be made from any known manufacturing methods appropriate for the above-listed materials. The form of a bellows constructed from the preferred plastics is accomplished through employment of a blow-molding step.

As can be seen in FIGS. 1 and 2, bellows 10 is formed with end 11 being open and end 12 closed. The open end provides access to bellows cavity 20. It may be desirable to have access to the cavity for cleaning purposes, to install optional features such as a filter or strainer, or to retrieve materials from within the bellows cavity.

An end cap 50, shown in FIG. 4, is provided for covering open end 11 of FIG. 1. End cap 50 includes a columnar opening 51 for liquid transfer into and out of the bellows cavity. In an alternative embodiment (not shown), both ends 11 and 12 may comprise removable end caps. End cap 50 is suitably made from the materials identified for bellows 10. The end caps are preferably made from a polyolefin or polyester and formed through a process including injection molding. The end cap may be secured to the bellows by means known in the art, such as, for example, threading, ultrasonic welding, fusion, interference fit, and/or with the use of additional components such as gaskets, sealants, or adhesives. Bellows 10 and one or more end caps 50 may be made from similar or dissimilar materials.

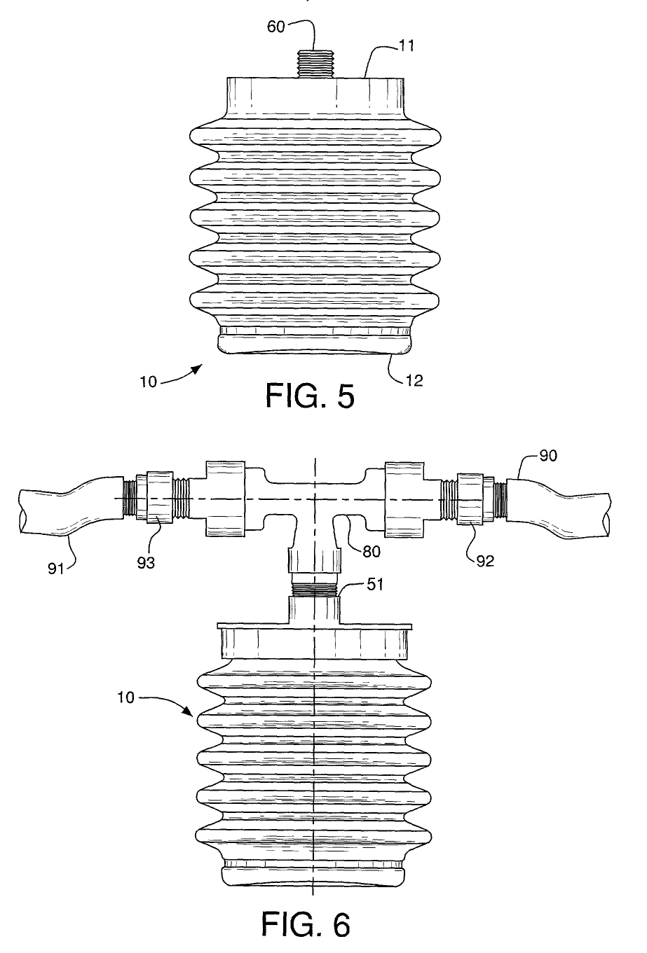

Alternatively and as shown in FIG. 5, ends 11 and 12 may be integrally formed as closed during the manufacture of bellows 10. Liquid transfer into and out of the bellows is through opening 60 (similar to opening 51 on end cap 50).

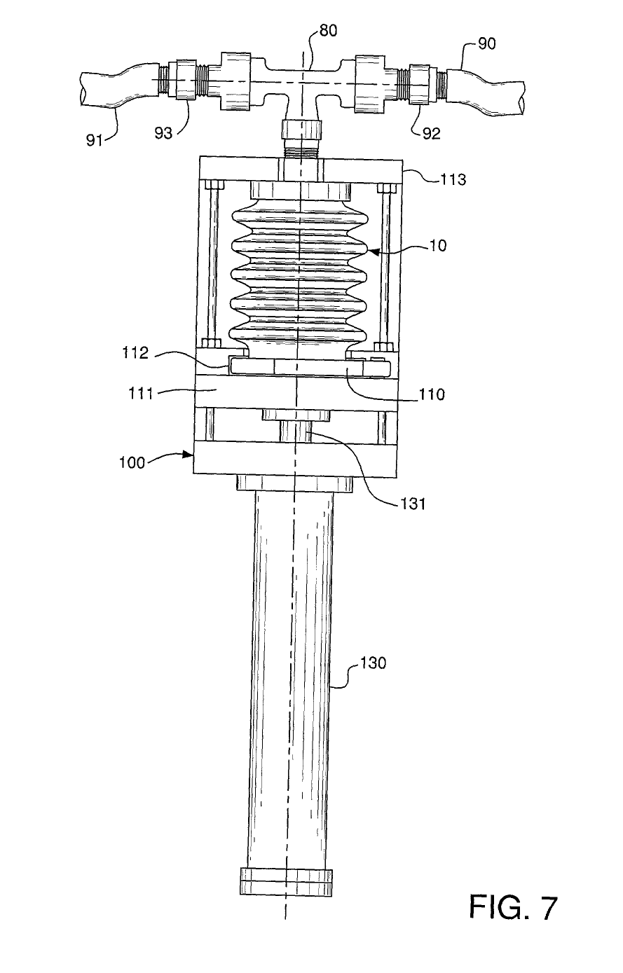

An actuator (shown as element 70 in FIG. 7) is preferably utilized for compressing the bellows. Suitable types of actuators include, but are not limited to, linear, rotary, and cam actuators. In preferred embodiments, a linear actuator is employed, such as a GS Series linear actuator commercially available from Exlar Corporation of Chanhassen, Minn. The chosen actuator may be programmable and controlled through the use of computer control systems (not shown), such that the amount of liquid displaced by the bellows is easily and quickly adjusted. For a linear type actuator, the stroke of the actuator may be adjusted depending on the size of the bellows, the rate of liquid flow, and the target volume desired for a particular application.

In a preferred embodiment, the actuator actively compresses and expands the bellows. In an alternative preferred embodiment, the actuator compresses the bellows, and potential energy expands the bellows (that is, the bellows acts like a spring). In this embodiment, potential energy is generated during compression of the bellows by the actuator. Accordingly, a bellows compression cycle begins with an expanded and primed bellows. An actuator compresses the bellows causing a contained target volume of liquid to be displaced to a container, and potential energy to be created. The actuator retracts and the potential energy is released causing the bellows to expand. As the bellows expands, newly sourced liquid is drawn into the bellows cavity, resulting in a subsequent contained target volume of liquid at the completion of the bellows expansion.

Referring now to FIG. 6, a T-fitting 80 is coupled to opening 51 located on capped end 11. T-fitting 80 joins an inlet conduit 90 and an outlet conduit 91, such that liquid is drawn into and displaced out of the bellows interior through opening 51. Inlet and outlet conduits may alternatively be coupled to separate openings in the bellows. Multiple openings can be located at varying positions on the bellows.

Inlet and outlet conduits 90, 91 preferably each comprise one-way valves to prevent liquid from flowing backwards during pumping. Although the one-way valves 92 and 93 are shown respectively at the end of conduits 90 and 91 and adjacent fitting 80, their location may vary. For example, a one-way valve for the inlet conduit may be positioned at the liquid source, and a one-way valve for the outlet conduit positioned at or near the point of dispensing. One-way valves may also be incorporated into a fitting, such as T-fitting 80, or the bellows themselves. A representative, non-limiting, list of useful one-way valves includes check valves, pinch valves, plug valves, butterfly valves, needle valves, and gate valves.

Dispensing systems according to the present invention are particularly useful for manufacturers offering a plurality of different liquid products and wanting to avoid cross contamination between different products, but do not have dedicated equipment for the entire product line. Essentially, all of the wetted components (those that come into contact with the liquid products) must be cleaned or replaced when the product changes. Changeover time (including machine downtime and cleaning downtime) between different products creates opportunity costs. The present invention reduces changeover times through numerous features.

In one preferred embodiment, all of the wetted components are designed to be disposable, such that the costs associated with replacing the wetted components assembly is comparably equal to or less than costs associated with cleaning prior art dispensing systems. Disposability can be realized in numerous ways, including manufacturing an entire wetted components assembly from a material comprising a plastic (or other relatively inexpensive and easily manufacturable material). A wetted components assembly as defined by the present invention includes a bellows, an inlet conduit, and an outlet conduit. The wetted components assembly may comprise additional features, such as, for example, conduit fittings, one-way valves, dispensing nozzles, quality control elements, screens or filters, and the like.

Along with inexpensive manufacturing materials, limiting the number of components employed in a wetted components assembly can increase the attractiveness of disposability (in comparison to cleaning). Many prior art bellows pumps comprise additional components within the cavity of the bellows, which provide a variety of functions, including controlling or facilitating compression and expansion of the bellows. In one preferred embodiment of the present invention, the bellows cavity is void of any additional components. Limiting the number of wetted components also reduces the number of potential failure origins and failure mechanisms (limited number of interfaces). Dispensing accuracy may also be improved due to a reduction in potential deviation sources.

The features providing a disposability option generally reduce the costs of components used in dispensing systems according to the present invention. Thus, these features may be employed in reusable (non-disposable) dispensing systems to reduce capital costs and improve dispensing accuracy and other operational concerns. Accordingly, the present invention is explicitly not limited to dispensing systems comprising disposable wetted components assemblies.

Improving disassembling efficiency may also reduce changeover time. By way of example, a quick-release coupling (including tool-less couplings and fasteners) can be employed to secure a wetted components assembly to complementary components of the dispensing system. Referring now to FIG. 7, a support member or housing 100 is provided with a quick-release clamp 110. Associated with support member 100 is a movable platen 111 having a seat 112 thereon configured to accept an end of a bellows 10. A linear actuator 130 is positioned under the support member 100 and the actuator's rod 131 is attached to movable platen 111. Support member 100 includes a top member 113 to support the bellows' opposing end.

Suitable quick-release couplings include, but are not limited to, toggle clamps, cam-action clamps, hinged collar clamps, spring rocker clamps, retaining structures with tool-less handbolts, and the like. The quick-release coupling allows an entire wetted components assembly to be engaged and disengaged with the remaining dispensing system components (for example, the support member and actuator) in a minimal number of steps, preferably in a single step.

Bellows pumps of the present invention, which include some or all of the features described above, are engineered for design stability and for highly accurate and repeatable liquid dosing. The bellows pumps are engineered to produce dosing accuracy within a tolerance of +/−0.5% or better by volume or weight, and for 6-sigma process control for a range of products and water. For liquids having a viscosity of about 1 cp at 21° C. (substantially the viscosity of water), dosing accuracy and repeatability is within +/−0.1% by volume or weight. For liquids having a higher viscosity, dosing accuracy and repeatability is within +/−0.5% by volume or weight. A dosing accuracy test includes starting the bellows pump and allowing to cycle for at least one minute, filling ten containers with ten consecutive compression cycles (that is, one cycle per container), and then measuring the volume and/or weight of the liquid in each container. For weight measurements, ten containers are weighed and numbered before filling and then weighed within 1 hour after filling, with the difference in weights representing the liquid weight.

Bellows pumps of the present invention are designed to operate within a wide range of temperatures and pressures, including vacuum. The bellows pumps are designed, based on the materials of construction, for durability, high cycle life and predictable failure mode.

### EXAMPLES

Bellows Configuration Example 1:

| | | |
|---|---|---|
| Number of Corrugations: | 13 | |
| Outer Diameter: | 12.5 | cm |
| Inner Diameter: | 10 | cm |
| Wall Thickness: | 2 | mm |
| Height: | 29 | cm |

Bellows Configuration Example 2:

| | | |
|---|---|---|
| Number of Corrugations: | 5 | |
| Outer Diameter: | 16.8 | cm |
| Inner Diameter: | 12.7 | cm |
| Wall Thickness: | 2 | mm |
| Height: | 17.5 | cm |

A number of materials were tested in the above bellows configurations by computer simulation at internal pressures (bellows interior) up to 4 bars. The following materials performed best for a cycle life of greater than 350 thousand cycles: RITEFLEX thermoplastic elastomers, ARISTECH polypropylene, GRILAMID nylon 12, SUNPRENE polyvinyl chloride elastomer, and PETROTHENE low-density polyethylene. The following materials did not perform as well: PETROTHENE polypropylene, TPX polyolefin, FORMLON ionomer, and QUANLUM high-density polyethylene.

### Example 3

Prototypes of the bellows as configured in Examples 1 and 2 above were made by blow molding. The bellows configuration of Example 2 was lab-tested for accuracy in dispensing liquid products. The laboratory set-up included the bellows of Example 2 with an end cap, standard King Brothers KING-CHEK inlet and outlet one-way valves, and an EXLAR GS series linear actuator controlled with an Allen-Bradley RS 5000 PLC computer. The bottle sizes being filled included 50 ml, 200 ml, 300 ml, 500 ml, and 750 ml. The dosing for each of these target volumes was done with a single compression cycle. For Johnson's Baby Shampoo, overall accuracy was within +/−0.5%.

It is to be understood that even though numerous characteristics and advantages of the present invention have been set forth in the foregoing description, together with details of the structure and function of the invention, the disclosure is illustrative only. Accordingly, changes may be made in detail, especially in matters of shape, size and arrangement of features within the principles of the invention to the full extent indicated by the broad general meaning of the terms in which the appended claims are expressed.

What is claimed is:

1. A method for filling a plurality of containers with a liquid product, said method comprising use of a pump wherein said pump comprises:
a bellows comprising a plurality of corrugations;
an inlet conduit in fluid communication with a cavity defined by said bellows;
an outlet conduit in fluid communication with said cavity; and
a controlled linear actuator for compressing said bellows; wherein each of said plurality of containers has a volume of at least about 50 ml and is filled with a single compression cycle of said bellows.

2. The method of claim 1, wherein liquid displacement by said bellows is repeatable within at least about +/−0.1% of a target volume for liquids having a viscosity of about 1 cp at 21° C.

3. The method of claim 1, wherein said bellows comprises a polyolefin and has a wall thickness of from about 1 mm to about 5 mm.

4. The method of claim 3, wherein said polyolefin comprises a polypropylene.

5. The method of claim 1, wherein each of said plurality of corrugations has an included angle of from about 5 degrees to about 60 degrees.

6. The method of claim 1, wherein each of said plurality of corrugations has a fillet radius of from about 2 mm to about 10 mm.

7. The method of claim 1, wherein said bellows comprises from 3 to 15 corrugations.

8. The method of claim 1, wherein said bellows comprises 5 corrugations, has an inner diameter of about 12 cm, and has an outer diameter of about 16 cm.

9. The method of claim 1, wherein said bellows comprises 13 corrugations, has an inner diameter of about 10 cm, and has an outer diameter of about 12 cm.

10. The method of claim 29, wherein each of said plurality of containers has a volume of at least about 200 ml.

11. The method of claim 1, wherein each of said inlet conduit and said outlet conduit comprises a one-way valve.

12. The method of claim 1, wherein said bellows is capable of withstanding up to at least about 200,000 compression cycles at internal pressures up to about 3 bar.

13. The method of claim 1, wherein when pumping liquids having a viscosity of up to about 80,000 cp at 21° C., dispensing accuracy is within +/−0.5% of a target volume.

14. A liquid dispensing system having a pump, said pump comprising:
a wetted components assembly comprising:
a bellows comprising a closed end and an opposing end having a single opening formed therein, a plurality of corrugations, a cavity, and a single cycle displacement volume of at least about 50 ml; and
inlet and outlet conduits in fluid communication with said single opening such that liquid can be drawn into and displaced out of said cavity through said single opening, each of said inlet conduit and said outlet conduit comprising a one-way valve; and
an actuator for compressing said bellows through force transmitted to an exterior thereof.

15. The liquid dispensing system of claim 14, wherein said wetted components assembly is made from a material comprising plastic.

16. The liquid dispensing system of claim 14, wherein said cavity is void of any additional components.

17. The liquid dispensing system of claim 14, further comprising a support member and a quick-release coupling for connecting said wetted components assembly thereto.

18. The liquid dispensing system of claim 14, wherein said bellows is blow-molded from a material comprising a polyolefin.

19. The liquid dispensing system of claim 14, wherein said actuator is a controlled linear actuator providing repeatable liquid displacement within about +/−0.1% of a target volume for liquids having a viscosity of about 1 cp at 21° C.

20. The liquid dispensing system of claim 14, wherein said bellows comprises from 3 to 15 corrugations.

21. The liquid dispensing system of claim 14, wherein said bellows has a single cycle displacement volume of at least about 200 ml.

22. The liquid dispensing system of claim 14, wherein said bellows is capable of withstanding up to at least about 200,000 compression cycles at internal pressures up to about 3 bar.

23. The liquid dispensing system of claim 14, wherein each of said plurality of corrugations includes substantially rigid sidewalls so that ballooning of said sidewalls is prevented at a internal pressure of about 4 bar.

24. A liquid dispensing system for filling containers with liquid products, said liquid dispensing system comprising:
a wetted components assembly comprising:
a bellows comprising a plurality of corrugations;
an inlet conduit in fluid communication with a cavity defined by said bellows; and
an outlet conduit in fluid communication with said cavity;
a support member;
a quick-release coupling for securing said wetted components assembly to said support member; and
a controlled linear actuator for compressing said bellows.

25. The liquid dispensing system of claim 24, wherein said wetted components assembly is made from a material comprising plastic.

26. The liquid dispensing system of claim 24, wherein said bellows has a single cycle displacement volume of at least about 50 ml.

27. The liquid dispensing system of claim 24, wherein each of said inlet conduit and said outlet conduit comprises a one-way valve.

28. The liquid dispensing system of claim 24, wherein said bellows and said controlled linear actuator provide repeatable liquid displacement within about +/−0.1% of a target volume for liquids having a viscosity of about 1 cp at 21° C.

29. A liquid dispensing system having a pump, said pump comprising:
a bellows comprising a plurality of corrugations and a single cycle displacement volume of at least about 50 ml, each of said plurality of corrugations including substantially rigid sidewalls so that ballooning of said sidewalls is prevented at an internal pressure of about 4 bar;
an inlet conduit in fluid communication with a cavity defined by said bellows;
an outlet conduit in fluid communication with said cavity; and
a controlled linear actuator for compressing said bellows.

30. The liquid dispensing system of claim 29, wherein said bellows has a single cycle displacement volume of at least about 200 ml.
